(19) United States
(12) Patent Application Publication
(10) Pub. No.: US 2014/0268105 A1
(43) Pub. Date: Sep. 18, 2014

(54) OPTICAL DEFECT INSPECTION SYSTEM

(71) Applicant: Zygo Corporation, Middlefield, CT (US)

(72) Inventors: Richard Earl Bills, Haddam, CT (US); Chris Koliopoulos, Tucson, AZ (US)

(73) Assignee: Zygo Corporation, Middlefield, CT (US)

(21) Appl. No.: 14/205,728

(22) Filed: Mar. 12, 2014

Related U.S. Application Data
(60) Provisional application No. 61/800,442, filed on Mar. 15, 2013.

(51) Int. Cl. G01N 21/88; G01B 9/02

(52) U.S. Cl. CPC G01N 21/88; G01B 9/02
USPC 356/51; 356/450

(57) ABSTRACT

Disclosed herein is a system for determining information about one or more defects on or in a test object. The system includes a light source configured to illuminate a test object with spatially coherent light; a multi-element detector positioned to detect an interference pattern of light associated with one or more defects on or in the illuminated test object; and an electronic control module in communication with the multi-element detector and configured to process the interference pattern to determine information about the one or more defects on or in the test object.

### CROSS-REFERENCE TO RELATED APPLICATIONS

This application claims benefit of the Provisional Application No. 61/800,442, entitled “OPTICAL DEFECT INSPECTION SYSTEM,” filed on Mar. 15, 2013. The entire content of this priority application is hereby incorporated by reference.

### BACKGROUND

This specification describes optical defect inspection and classification, for example defect inspection technologies based on digital inline holographic microscopy.

Optical quality glasses are routinely used to fabricate precision polished lenses, flats, prisms, and polarization optics for optical and electro-optical instrumentation. Such instruments can include, but are not limited to: digital cameras, industrial inspection equipment, laser ranging systems, optical surveying equipment, ground and space-based optics, telescopes and binoculars, fiber-optic communication systems, and optics-based medical and biological instrumentation. Unlike the semiconductor and hard disk manufacturing industries, the optics industry still relies on old-fashioned labor-intensive visual inspection processes to locate and identify surface defects. This process may be fraught with variability and inconsistency, involving drawings that utilize an old, outdated military scratch-dig standard (MIL-O-13830A and MIL-PRF-13830B) that uses an inspector to make a visual determination by comparing defects to a visual artifact (scratch/dig paddle). Although newer standards (ISO-10110-7 and ANSI/OEOSC OP1.002-2009) define dimensional specifications that allow a designer to clearly define the maximum sizes and the number of allowable defects, they do not specify a method for inspection. As indicated in the ISO-10110-7 specification, methods for inspection often entail careful initial human visual inspection to locate defects of interest, and then manual measurements of these defects using a standard microscope.

Although an automated optical microscope can be used for defect inspection, the throughput may be inadequate in certain cases due to the limited speed with which the camera frames can be read and processed, and the high magnification and limited field-of-view required for reliable detection of 10 micron defects (#10 scratch or #1 dig). Microscopes can only inspect a small sub-region of an optic with a field of view that is limited to only a few mm, and they can only inspect one surface at a time. Typically, a user picks and places the test object twice using at least 2 different microscope setups. Potentially expensive mechanical motorized stages are used to sequentially move the optical test surfaces into the field-of-view, and additional software-controlled Z-stage and tilt-stages are required to position the test objects to clearly image curved lens surfaces across the camera field-of-view. Clean precision polished optics must be used in the microscope for scratch-dig inspection since defects within the microscope optics can be accidentally misinterpreted as defects on the test surfaces. In light of these technical considerations, automated microscopes are primarily relegated to high end applications (e.g. lithography optics inspection or limited batch sampling) due to their complexity, cost, and potentially low throughput. A Scanning White Light Interference (SWLI) microscope can also be considered for scratch/dig inspection since it provides micron-scale height information that could potentially be used for surface defect identification and classification. However, this would add even more cost and complexity to the microscope system described above.

Conventional laser and camera-based optical inspection systems are typically used for large flat sheets of glass, such as LCD TFT display panels. These systems tend to be optimized for relatively large defects (usually much larger than 50 microns), and are scaled to handle large, flat sheets of glass rather than small optical flats and curved lens surfaces. In contrast to the foregoing type of conventional systems, the inspection systems described in this specification can be used for scratch/dig inspection of precision polished optics.

Although the detection of defects is a critical requirement for many applications, it is also highly desirable to identify the type of defects that are on or in a surface. This defect type information can then be used to determine the disposition of the part for further reprocessing. For example, if a point defect is due to a pit in the surface, it must be removed by re-polishing the surface. If it is due to debris, it can be removed with a cleaning process. High volume inspection processes often require this kind of defect identification capability in order to sort the parts into the appropriate “pass”, “re-clean”, and “re-polish” work streams.

Although the discussion above is focused on defect inspection in optics, the technologies described herein are not limited solely to the inspection of glass. The semiconductor industry also requires automated, high throughput microscopic inspection. Defects such as silicon microcracks, edge chips, slurry residue, silicon bubbles or voids, and relatively large scale debris must be rapidly identified between semiconductor processing steps. The limitations of conventional microscopes that were previously described for scratch/dig inspection also apply to semiconductor applications as well. Although the term “scratch/dig” will be routinely applied throughout the text, those skilled in the art will understand that the same techniques can also be applied to the inspection of other types of defects on and in non-glass transparent and specularly reflective substrates for other industrial applications.

### SUMMARY

In general, one innovative aspect of the subject matter described in this specification can be embodied in a system for determining information about one or more defects on or in a test object. The system includes a light source configured to illuminate a test object with spatially coherent light; a multi-element detector positioned to detect an interference pattern of light associated with one or more defects on or in the illuminated test object; and an electronic control module in communication with the multi-element detector and configured to process the interference pattern to determine information about the one or more defects on or in the test object.

These and other embodiments may each optionally include none, one or more of the following features.

In transmission-mode embodiments, the interference pattern can be produced by the spatially coherent light that transmits through at least a portion of the test object without being scattered and source light which is scattered by the one or more defects. Here, the spatially coherent light transmits through a volume of the test object extending from an entry surface of the test object to an exit surface of the test object within a field of view of the multi-element detector, and the one or more defects are on the entry surface, on the exit surface, or in the volume of the test object within or adjacent the field of view of the multi-element detector. Additionally, the electronic control module can be configured to process the interference pattern to determine characteristics of the source light at two or more surfaces of the test object, the two or more surfaces including any combination of the entry surface, the exit surface, or one or more inner surfaces within the volume of the test object; determine the information about the one or more defects from the determined characteristics; and classify the one or more defects based on the determined information as one or more of (a) a scratch or dig of the entry or exit surfaces, (b) a void located inside the test object volume, and (c) debris located on the entry or exit surfaces or at one of the inner surfaces of the test object volume. Further, when the test object includes a prism, a first one of the two or more surfaces can be a first surface of the prism and a second one of the two or more surfaces can be a second surface of the prism which is at an angle with respect to the first surface of the prism. Furthermore, the determined characteristics of the source light can include two or more of amplitude, phase or intensity, and the two or more surfaces are separated by distances larger than or equal to an axial resolution of the system.

In reflection-mode embodiments, defects can be detected by source/detector combinations at a plurality of reflection angles and/or wavelengths. Information from the multiple source angles and/or wavelengths can used by the electronic control module to identify the type of each detected defect in the following manner. Here, the interference pattern is produced by the spatially coherent light which reflects from at least a portion of the test object without being scattered and source light which is scattered by the one or more defects. Moreover, the spatially coherent light reflects from a test surface of the test object, the test surface being within a field of view of the multi-element detector, and the one or more defects are on the test surface within or adjacent the field of view of the multi-element detector. Additionally, the electronic control module can be configured to process the interference pattern to determine characteristics of the source light at the test surface of the test object; determine the information about the one or more defects from the determined characteristics; and classify the one or more defects based on the determined information as one or more of (a) a scratch or dig of the test surface, and (b) debris located on the test surface. Further, the determined characteristics of the source light can include two or more of amplitude, phase or intensity.

In some implementations of the reflection-mode embodiments, the light source can be configured to output multiple wavelengths of the source light, the determined information about the one or more defects can include a defect brightness, and the electronic control module can be configured to classify (i) a defect for which the defect brightness varies at different wavelengths of the source light as a defect with smooth surface features, and (ii) a defect for which the defect brightness is substantially constant at the different wavelengths of the source light as a defect with rough surface features.

In other implementations of the reflection-mode embodiments, the light source can be configured to illuminate the test object at different incident angles, the determined information about the one or more defects can include a defect brightness, and the electronic control module can be configured to classify (i) a defect for which the defect brightness varies at the different incident angles as a flat defect with a ε:1 depth-to-width ratio, where |ε|≦≦1, and (ii) a defect for which the defect brightness is substantially constant at the different incident angles as a blob defect with about 1:1 depth-to-width ratio.

In some other implementations of the reflection-mode embodiments, the light source can be configured to illuminate the test object at different incident angles, the determined information about the one or more defects can include a defect size, and the electronic control module can be configured to classify (i) a defect for which the defect size varies at the different incident angles as a flat defect with a ε:1 depth-to-width ratio, where |ε|<<1, and (ii) a defect for which the defect size is substantially constant at the different incident angles as a blob defect with about 1:1 depth-to-width ratio.

In yet some other implementations of the reflection-mode embodiments, the light source can be configured to output multiple wavelengths of the source light and to illuminate the test object at different incident angles, the determined information about the one or more defects can include a defect brightness, and the electronic control module can be configured to classify (i) a defect for which the defect brightness (i) is substantially constant at different wavelengths of the source light and (ii) varies at the different incident angles as a flat defect with rough surface features, and (ii) a defect for which the defect brightness (A) is substantially constant at the different wavelengths of light and (B) is substantially constant at the different incident angles as a blob defect with rough surface features.

In yet some other implementations of the reflection-mode embodiments, the light source can be configured to output multiple wavelengths of the source light and to illuminate the test object at different incident angles, the determined information about the one or more defects can include a defect brightness and a defect size, and the electronic control module can be configured to classify (i) a defect for which (A) the defect brightness is substantially constant at different wavelengths of the source light and (B) the defect size varies at the different incident angles as a flat defect with rough surface features, and (ii) a defect for which (A) the defect brightness is substantially constant at the different wavelengths of the source light and (B) the defect size is substantially constant at the different incident angles as a blob defect with rough surface features.

In yet some other implementations of the reflection-mode embodiments, the light source can be configured to output multiple wavelengths of the source light and to illuminate the test object at different incident angles, the determined information about the one or more defects can include a defect brightness, and the electronic control module can be configured to classify (i) a defect for which the defect brightness (A) varies at different wavelengths of the light and (B) varies at the different incident angles as a flat defect with smooth surface features, and (ii) a defect for which the defect brightness (A) varies at the different wavelengths of the light and (B) is substantially constant at the different incident angles as a blob defect with smooth surface features.

In yet some other implementations of the reflection-mode embodiments, the light source can be configured to output multiple wavelengths of the source light and to illuminate the test object at different incident angles, the determined information about the one or more defects can include a defect brightness and a defect size, and the electronic control module can be configured to classify (i) a defect for which (A) the defect brightness varies at different wavelengths of the light and (B) the defect size varies at the different incident angles as a flat defect with smooth surface features, and (ii) a defect for which (A) the defect brightness varies at the different wavelengths of the light and (B) the defect size is substantially constant at the different incident angles as a blob defect with smooth surface features.

In some cases, the test object can include one or more layers defined by any combination of transparent surfaces, semi-transparent surfaces, non-transparent surfaces, and reflecting surfaces. Here, the electronic control module can be configured to process the interference pattern to determine whether each of the one or more defects is a scratch or dig of one of the surfaces defining the one or more layers of the test object, and if so, determine on which one of the surfaces the scratch or dig is located.

In some cases, the determined information about the one or more defects can include distances between the one or more defects and the multi-element detector.

In some embodiments, the electronic control module can be configured to process the interference pattern to classify the one or more defects based on the determined information as one or more of (a) a scratch or dig of an entry or exit surface of the test object, (b) a void located inside the test object, and (c) debris. For example, the electronic control module is configured to process the interference pattern to determine whether each of the one or more defects is a scratch or dig of an entry or exit surface of the test object.

In some embodiments, the system does not include any imaging optics between a mount that supports the test object and the multi-element detector.

In some embodiments, the system can include a display configured to show a visual representation of the defects on or in the test object based on the interference pattern processed by the electronic control module.

In some embodiments, the spatially coherent light can be in any of the ultraviolet, visible, near-infrared, or infrared regions of the electromagnetic spectrum. In some embodiments, the light source can be configured to produce the spatially coherent light with a temporal coherence low enough to substantially eliminate any contributions to the interference pattern besides those caused by the one or more defects on or in the test object. For example, the light source is configured to output multiple wavelengths of light, the multi-element detector is configured to acquire instances of the interference pattern at two or more of the multiple wavelengths of light, and the electronic control module is further configured to average the acquired instances of the interference pattern. As another example, the light source includes a laser diode operated below a lasing threshold to provide the low temporal coherence. As yet another example, the light source includes a superluminescent diode. As yet another example, the light source is an LED in combination with a pinhole to provide high spatial coherence with low temporal coherence. As yet another example, the light source is a laser diode having a laser cavity that can be modulated, and the laser diode is configured to operate above a lasing threshold while its laser cavity is being modulated faster than an acquisition frame period of the multi-element detector to provide the low temporal coherence.

In some cases, the determined information can include (i) location information including lateral and axial locations of the one or more defects of the test object volume, and (ii) morphological information thereof. Further, the electronic control module can be configured to process the interference pattern to classify whether each of the one or more defects is a scratch or dig of a surface of the test object based on the location information and the morphological information. Here, the electronic control module determines size and quantity of the classified one or more defects of the test object, and provides an indication whether either the determined size exceeds a target size, or the determined quantity exceeds a target quantity, or a combination of the determined size and quantity exceeds a target combination. Furthermore, the determined information further can include a representation of a surface at a given axial location of the test object volume where characteristics of the source light are estimated, and the representation of the surface at the given axial location can depict at least lateral locations of defects of the test object volume located adjacent to the surface at the given axial location and morphological information thereof.

In some embodiments, the system can include a mount configured to move the test object laterally such that a second interference pattern is recorded by the multi-element detector, the second interference pattern corresponding to an adjacent portion of the test object. Here, the electronic control module can be configured to process the second recorded interference pattern to determine information about additional defects on or in the test object, generate a representation of a surface of the adjacent test object portion, and stitch together the representations of the adjacent portions of the test object.

In some embodiments, the multi-element detector can include a mosaic of sensor arrays arranged with respect to the light source, such that one of the mosaic of sensor arrays records the interference pattern corresponding to the test object volume, and remaining ones of the mosaic of sensor arrays record additional interference patterns corresponding to other, adjacent test object volumes. Here, the electronic control module can be configured to stitch the interference pattern and the additional interference patterns into an extended interference pattern corresponding to an extended volume of the test object, the extended volume of the test object including the test object volume and the other, adjacent test object volumes, and determine information about defects of the extended volume of the test object.

Another innovative aspect of the subject matter described in this specification can be embodied in a method for determining information about one or more defects on or in a test object. This method includes illuminating a test object with spatially coherent light; detecting an interference pattern of light associated with one or more defects on or in the illuminated test object; and processing the interference pattern to determine information about the one or more defects on or in the test object.

These and other embodiments may each optionally include none, one or more of the following features.

In transmission-mode embodiments, the method can include producing the interference pattern from the spatially coherent light that transmits through at least a portion of the test object without being scattered and source light which is scattered by the one or more defects. Here, the spatially coherent light transmits through a volume of the test object extending from an entry surface of the test object to an exit surface of the test object within a field of view of a multi-element detector used to detect the interference pattern, and the one or more defects are on the entry surface, on the exit surface, or in the volume of the test object within or adjacent the field of view. Here, processing the interference pattern to determine information about the one or more defects on or in the test object can include processing the interference pattern to determine characteristics of the source light at two or more surfaces of the test object, the two or more surfaces including any combination of the entry surface, the exit surface, or one or more inner surfaces within the volume of the test object; determining the information about the one or more defects from the determined characteristics; and classifying the one or more defects based on the determined information as one or more of (a) a scratch or dig of the entry or exit surfaces, (b) a void located inside the test object volume, and (c) debris located on the entry or exit surfaces or at one of the inner surfaces of the test object volume. Further, the determined characteristics of the source light can include two or more of amplitude, phase or intensity, and the two or more surfaces are separated by distances larger than or equal to an axial resolution.

In reflection-mode embodiments, the method can include producing the interference pattern from the spatially coherent light which reflects from at least a portion of the test object without being scattered and source light which is scattered by the one or more defects. In this case, the spatially coherent light reflects from a test surface of the test object, the test surface being within a field of view of a multi-element detector, and the one or more defects are on the test surface within or adjacent the field of view of the multi-element detector. Here, processing the interference pattern to determine information about the one or more defects on or in the test object can included processing the interference pattern to determine characteristics of the source light at the test surface of the test object; determining the information about the one or more defects from the determined characteristics; and classifying the one or more defects based on the determined information as a defect having a type including one or more of (a) a scratch or dig of the test surface, and (b) debris located on the test surface. Further, the determined characteristics of the source light can include two or more of amplitude, phase or intensity.

In some implementations of the reflection-mode embodiments, illuminating the test object can be performed with multiple wavelengths of the source light, the determined information about the one or more defects can include a defect brightness, and classifying the one or more defects can include (i) classifying a defect for which the defect brightness varies at different wavelengths of the source light as a defect with smooth surface features, and (ii) classifying a defect for which the defect brightness is substantially constant at the different wavelengths of the source light as a defect with rough surface features.

In other implementations of the reflection-mode embodiments, illuminating the test object can be performed at different incident angles, the determined information about the one or more defects can include a defect brightness, and classifying the one or more defects can include (i) classifying a defect for which the defect brightness varies at the different incident angles as a flat defect with a ε:1 depth-to-width ratio, where |ε|<<1, and (ii) classifying a defect for which the defect brightness is substantially constant at the different incident angles as a blob defect with about 1:1 depth-to-width ratio.

In some other implementations of the reflection-mode embodiments, illuminating the test object can be performed at different incident angles, the determined information about the one or more defects can include a defect size, and classifying the one or more defects can include (i) classifying a defect for which the defect size varies at the different incident angles as a flat defect with a ε:1 depth-to-width ratio, where |ε|<<1, and (ii) classifying a defect for which the defect size is substantially constant at the different incident angles as a blob defect with about 1:1 depth-to-width ratio.

In yet some other implementations of the reflection-mode embodiments, illuminating the test object can be performed with multiple wavelength of the source light and at different incident angles, the determined information about the one or more defects can include a defect brightness, and classifying the one or more defects can include (i) classifying a defect for which the defect brightness (A) is substantially constant at the different wavelengths of light and (B) varies at the different incident angles as a flat defect with rough surface features, and (ii) classifying a defect for which the defect brightness (A) is substantially constant at the different wavelengths of light and (B) is substantially constant at the different incident angles as a blob defect with rough surface features.

In yet some other implementations of the reflection-mode embodiments, illuminating the test object can be performed with multiple wavelength of the source light and at different incident angles, the determined information about the one or more defects can include a defect brightness and a defect size, and classifying the one or more defects can include (i) classifying a defect for which (A) the defect brightness is substantially constant at the different wavelengths of light and (B) the defect size varies at the different incident angles as a flat defect with rough surface features, and (ii) classifying a defect for which (A) the defect brightness is substantially constant at the different wavelengths of light and (B) the defect size is substantially constant at the different incident angles as a blob defect with rough surface features.

In yet some other implementations of the reflection-mode embodiments, illuminating the test object can be performed with multiple wavelength of the source light and at different incident angles, the determined information about the one or more defects can include a defect brightness, and classifying the one or more defects can include (i) classifying a defect for which the defect brightness (A) varies at different wavelengths of the light and (B) varies at the different incident angles as a flat defect with smooth surface features, and (ii) classifying a defect for which the defect brightness (A) varies at the different wavelengths of the light and (B) is substantially constant at the different incident angles as a blob defect with smooth surface features.

In yet some other implementations of the reflection-mode embodiments, illuminating the test object can be performed with multiple wavelength of the source light and at different incident angles, the determined information about the one or more defects can include a defect brightness and a defect size, and classifying the one or more defects can include (i) classifying a defect for which (A) the defect brightness varies at different wavelengths of the light and (B) the defect size varies at the different incident angles as a flat defect with smooth surface features, and (ii) classifying a defect for which (A) the defect brightness varies at the different wavelengths of the light and (B) the defect size is substantially constant at the different incident angles as a blob defect with smooth surface features.

In some cases, the test object can include one or more layers defined by any combination of transparent surfaces, semi-transparent surfaces, non-transparent surfaces, and reflecting surfaces. Here, processing the interference pattern can include determining whether each of the one or more defects is a scratch or dig of one of the surfaces defining the one or more layers of the test object, and if so, determining on which one of the surfaces the scratch or dig is located.

In some implementations, processing the interference pattern can include classifying the one or more defects based on the determined information as one or more of (a) a scratch or dig of an entry or exit surface of the test object, (b) a void located inside the test object, and (c) debris. For example, the method can include determining whether each of the one or more defects is a scratch or dig of an entry or exit surface of the test object.

In some implementations, detecting the interference pattern is performed without using any imaging optics between a mount that supports the test object and a multi-element detector that detects the interfering pattern.

In some implementations, the method can include displaying a visual representation of the defects on or in the test object based on the interference pattern.

In some cases, the spatially coherent light can be in any of the ultraviolet, visible, near-infrared, or infrared regions of the electromagnetic spectrum.

In some implementations, the method can include producing the spatially coherent light with a temporal coherence low enough to substantially eliminate any contributions to the interference pattern besides those caused by the one or more defects on or in the test object. Further, the determined information can include (i) location information including lateral and axial locations of the one or more defects of the test object volume, and (ii) morphological information thereof. Here, processing the interference pattern can include classifying whether each of the one or more defects is a scratch or dig of a surface of the test object based on the location information and the morphological information. The method also can include determining size and quantity of the classified one or more defects of the test object, and providing an indication whether either the determined size exceeds a target size, or the determined quantity exceeds a target quantity, or a combination of the determined size and quantity exceeds a target combination. Furthermore, the method can include displaying a representation of a surface at a given axial location of the test object volume where characteristics of the source light are estimated, such that the representation of the surface at the given axial location depicts at least lateral locations of defects of the test object volume located adjacent to the surface at the given axial location and morphological information thereof.

In some implementations, the method can include moving the test object laterally and detecting a second interference pattern that corresponds to an adjacent portion of the test object; processing the second interference pattern to determine information about additional defects on or in the test object; generating a representation of a surface of the adjacent test object portion, and stitching together the representations of the adjacent portions of the test object.

In some implementations, the method can include detecting additional interference patterns along with the previously mentioned interference pattern, the additional interference patterns corresponding to other, adjacent test object portions; stitching together the previously mentioned interference pattern and the additional interference patterns into an extended interference pattern corresponding to an extended portion of the test object, the extended portion of the test object including the above mentioned test object portion and the other, adjacent test object portions; and determining information about defects of the extended portion of the test object.

Further aspects, features, and/or advantages are described below.

### BRIEF DESCRIPTION OF THE FIGURES

FIG. 1 shows a schematic representation of an example of a Digital In-line Holographic Microscopy (DIHM) system in transmission mode.

FIGS. 2A and 2B show a schematic representation of an example of a DIHM system in reflection mode for a) a defect in the surface, and b) debris on top of the surface, respectively.

FIG. 3 is a flow chart of a process performed by the ECM for detecting defects in desired reconstruction surfaces.

FIG. 4 shows that the DIHM system of FIG. 1 and the process of FIG. 3 can be used for single-shot detection of defects on the entry and exit surfaces and on the hypotenuse of a polarization beam splitter (PBS) cube.

FIG. 5 shows an example of an implementation of a DIHM system in transmission mode.

FIG. 6 shows an example of an implementation of a DIHM system in transmission mode for high resolution defect detection.

FIG. 7 shows an example of an image tiling pattern used in the DIHM system of FIG. 6.

FIG. 8 shows a tiled image of a test object (TO) generated using the image tiling pattern of FIG. 7.

FIGS. 9A-9B show aspects of a defect detected on the entry surface of the TO using the tiled image of FIG. 8.

FIGS. 10A-10B show aspects of a defect detected on the exit surface of the TO using the tiled image of FIG. 8.

FIG. 11 is a flow chart of a process performed by the ECM for classifying defects detected using the DIHM system of FIG. 6.

FIG. 12 shows an example of a graphical user interface (GUI) of the DIHM system of FIG. 6 that is used to display defect classification.

FIGS. 13A-13C show images of a standard #10 scratch defect on a standard scratch/dig paddle that is routinely used for comparative human visual qualitative inspections according to MIL-PRF-13830B.

FIGS. 14A-14C show images of a non-cleanable defect, a cleanable defect and a dig, respectively.

FIGS. 15A-15C show aspects of another example of a DIHM system in transmission mode (with lateral-rotational scanning) for defect detection of spherical (non-planar) objects.

FIG. 16 shows another example of a DIHM system in transmission mode (with lateral scanning) for defect detection of semiconductors objects.

FIG. 17 is a flow chart of a process performed by an electronic controller module (ECM) for stitching together flaw maps of N-FOVs corresponding to the lateral-scan patterns of FIGS. 15B-15C.

FIG. 18 is a block diagram of an example of a system electrical architecture.

Like reference numbers and designations in the various drawings indicate like elements.

### DETAILED DESCRIPTION

Systems and techniques for performing “scratch-dig inspection” in the optics industry are described. The disclosed technologies enable scratch-dig defect inspection on optical components (e.g. precision polished windows, lenses, and prisms) using digital holographic or diffractive techniques. Defects that can be detected and characterized by the disclosed technologies include scratches and digs in optical surfaces, bubbles located within the interior of the optical glass substrate, optical coating voids, and debris located within inner cement layers. Cleanable surface debris such as fibers, dust particles, fingerprints, and ink stains also are detected and characterized by the disclosed technologies. Note that the defect inspection techniques described herein can also be extended to inspecting other types of substrates, such as silicon wafers.

In its simplest Digital In-line Holographic Microscopy (DIHM) configuration, an inspection system includes a spatially coherent light source, a digital camera, and a computer that processes a camera image to extract scratch/dig defect images and morphological information throughout the detected volume of the illuminated test object. The processing algorithm typically uses some form of back propagation method that is conventional in digital holography. This algorithm calculates the scalar electric field amplitude and phase at the desired reconstruction image plane. Defects at this plane are classified and counted according to their various characteristics (point, area, line, scratches, size, opacity, edge roughness, etc.) and displayed on a composite processed defect map. This information is further processed to produce a composite scratch/dig measurement value based on a scratch/dig standard (e.g. ISO 10110-7), and a pass/fail decision is generated based on a user-defined “recipe”. Unlike some conventional inspection technologies, the disclosed technologies do not require critical placement of the test object with respect to a lens-based microscope inspection head's optical axis, and do not require multiple image frame acquisitions over multiple head positions along the optical axis to inspect multiple image planes within the test object. Instead, all of the desired scratch/dig information is extracted from within the field-of-view of one image frame. An optic under test is placed between the light source and camera, one image frame is captured, and then all of the defects on the surface and within the interior of the optic that are located within the camera field-of-view are algorithmically detected and characterized at once, thereby saving frame acquisition time and Z-scan motorized hardware costs. Also, unlike some conventional inspection technologies, the magnification can be flexibly changed by simply repositioning the test object with respect to the camera, thereby eliminating microscope objective changes. Furthermore, the inspection systems described in this specification eliminate the additional cost and the unwanted secondary images associated with microscope objectives in prior art systems.

In some implementations, an inspection system can include components necessary to scan a test object that is larger than the system's holographic illumination/detection volume. In this case, the inspection system automatically scans a flat or curved optical component and stitches together multiple image field-of-views to produce one mosaic image from which the scratch-dig measurements can be derived.

In some implementations, an inspection system can include a tiled mosaic of cameras or, optionally, a camera on X-Y motor stages. This expands the effective size of the camera and improves the effective resolution of the inspection system.

In some implementations, an inspection system can include multiple sources for the purpose of obtaining additional defect classification information using DIHM, spatial carrier Digital Holographic Microscopy (DHM), or phase-shifting methods. The sources may be oriented in nominally common path or even non-common path configurations.

In some implementations, an inspection system can be configured in reflective DIHM and/or DHM configurations to perform scratch-dig inspection on mirrors and other opaque polished surfaces.

Embodiments can be implemented so as to realize one or more of the following advantages. The disclosed technologies enable an optical glass surface defect inspection instrument that is scalable—one that may be cost-effective for smaller-sized optical shops, but can be scaled to higher throughput levels for larger optics shops. The minimum resolvable scratch/dig feature that should be detected is set by the scratch sensitivity, which for the inspection systems described in this specification is <10 microns. In this manner, the disclosed technologies can resolve a #10 scratch, which is 10 microns in width, and a 50 micron dig, and hence, the described inspection systems support a minimum scratch/dig sensitivity of 10/5 (MIL-PRF-13830B).

Further, the disclosed technologies take the guess-work out of optical inspection by providing a map of all of the surface defects greater than a user-specified size range. The defect map may be processed and binned in much the same manner as semiconductor wafer inspection systems. Additionally, the inspection systems described in this specification offer a high throughput mode for inspecting large areas of glass quickly at reduced sensitivity. The net benefits of the described technologies are substantially reduced labor costs, and reduction of the variability and inconsistency that are typically attributed to non-quantitative, human optical scratch/dig inspection methods.

FIG. 1 shows a schematic representation of an example of a defect inspection system 100 based on a digital in-line holographic microscope (DIHM) configured in transmission mode. This implementation of the defect inspection system 100 can be used to inspect a transparent sub-region of a test object (TO), such that a user manually moves the test object in the direction perpendicular to the optical axis (e.g., the z-axis) while viewing detected defects (e.g., D₁, D₂, D₃) on a live display associated with the defect inspection system 100. For instance, this implementation of the defect inspection system 100 can be used by the user to quickly locate isolated debris and defects in the test object. Automated motorized scanning implementations of defect inspection systems 1500 and 1600 are described below in connection with FIGS. 15A and 16.

The defect inspection system 100 includes a light source (LS), a multi-element detector (MED) and an electronic control module (ECM.) The defect inspection system 100 also includes support elements (not shown in FIG. 1) arranged to maintain a known distance z_{LS} from the multi-element detector to the light source, and to maintain another known distance z_{N} from the multi-element detector to the test object. The light source is arranged and configured to emit a spatially coherent beam of light (represented in FIG. 1 with dotted lines) which illuminates an entry surface S₁ of the test object. In this manner, most of the spatially coherent beam of light transmits through the test object and arrives at the multi-element detector with minimal scattering. This constitutes the reference wave RW. A remaining portion of the spatially coherent beam of light is influenced (in-line) by one or more defects D₁, D₂, D₃ which create a scattered light beam by diffraction. Wavelets w₁, w₂ and w₃ of the scattered light beam correspond to scattering events from respective defects D₁, D₂, D₃. The wavelets w₁, w₂ and w₃ interfere with the reference wave RW at the multi-element detector.

The multi-element detector is configured to acquire an image I-TO of the portion of the test object which is in the field of view (FOV) of the defect inspection system 100. The image I-TO is formed from a combination of the portion of the spatially coherent beam that transmits through the test object with minimal scattering and the scattered beam. In this manner, an interference pattern (IP) included in the acquired image I-TO carries information about all the defects (regardless of whether they are located on the entry or exit surfaces, S₁, S_{N}, or inside the volume) of the test object that have influenced the spatially coherent beam as it transmitted through the test object.

In order for the interference pattern included in the acquired image I-TO to carry information only (or mostly) about the defects, no (or very little) light reflected/scattered from other surfaces should contribute to the interference pattern at the multi-element detector. For this reason, it is important to avoid (or minimize) additional interference resulting from combinations of the reference beam with beams reflected by the entry and/or exit surfaces S1, SN, for instance. Such unwanted additional interference can be avoided by using an illuminating light source that is temporally incoherent or has low temporal coherence. For example, a light source has low temporal coherence if the emitted light has a temporal coherence length effectively shorter than the thickness |z₁−z_{N}| of the test object. As another example, a light source has low temporal coherence if the emitted light has a temporal coherence length effectively shorter than the distance between reflective surfaces within the volume of the test object. Light sources used in the defect inspection system 100 that output light with high spatial coherence and low temporal coherence are described below in connection with FIG. 5.

The electronic control module processes the acquired image I-TO to parse the information about the defects D₁, D₂, D₃ of the test object that is encoded in the image I-TO. A typical processing algorithm uses some form of back propagation method that is conventional in digital holography. Through such algorithm, the electronic control module calculates scalar electric field amplitude and phase at any of the desired reconstruction image planes. In the example illustrated in FIG. 1, the reconstruction image planes, separated from the multi-element detector by known distances, z₁, z_{N}, zᵢ and zⱼ respectively correspond to the entry surface S₁, the exit surface S_{N}, and surfaces Sᵢ, Sⱼ inside the volume of the test object. In some cases, the test object may be composed of transparent two or more layers, semi-transparent layers, non-transparent layers and reflecting layers. Here, the surfaces Sᵢ, Sⱼ inside the volume of the test object may correspond to at least some interfaces between the layers of the test object. In other cases, the test object may include no layer. Here, the surfaces Sᵢ, Sⱼ inside the volume of the test object are nominal (virtual) surfaces.

A set of images I-S₁, I-Sᵢ, I-Sⱼ and I-S_{N} of the electric field amplitude (or phase or intensity) corresponding to the test object surfaces S₁, Sᵢ, Sⱼ and S_{N} can be generated by the defect inspection system 100. The set of images I-S₁, I-Sᵢ, I-Sⱼ and I-S_{N} can be further analyzed by the electronic controller module to detect whether defects are present on these surfaces, and if so to determine an associated location (x, y, z) for each of the detected defects. Examples of processes used by the defect inspection system 100 to detect defects based on the acquired image I-TO are described below in connection with FIG. 3.

In the example illustrated in FIG. 1, the defect inspection system 100 can detect a defect D₁ on the exit surface S_{N}, a defect D₃ on the entry surface S₁, a defect D₂ on a surface Sⱼ and no defects on another surface Sᵢ by processing a single image I-TO of the test object. To obtain similar information, with defect inspection systems based on conventional microscopy, four images focused on the surfaces of interest S₁, Sᵢ, Sⱼ and S_{N} would have to be acquired.

The set of images I-S₁, I-Sᵢ, I-Sⱼ and I-S_{N} can be displayed to a user of the defect inspection system 100. In some implementations, the images in the set can be displayed individually, so that only one image occupies the display. In some implementations, the images can be displayed concurrently, for example tiled in the manner illustrated in FIG. 1.

The defects detected in the set of images I-S₁, I-Sᵢ, I-Sⱼ and I-S_{N} can be further analyzed by the electronic controller module. For instance, various defect characteristics are measured (point, area, line, scratches, size, opacity, edge roughness, etc.). In this manner, the detected defects can be counted and classified according to their measured characteristics. In the example illustrated in FIG. 1, the defect D₁ on the exit surface S_{N} may be classified as a scratch, the defect D₃ on the entry surface S₁ may be classified as a dig, and the defect D₂, which is buried under the exit surface at a depth d=|zⱼ−z_{N}|, may be classified as a void. Examples of processes used by the defect inspection system 100 to classify defects are described below in connection with FIG. 11.

While the defect inspection system 100 uses a transmission mode in operation, other inspection systems can be configured to operate in reflection mode, in accordance with the disclosed technologies.

Each of FIGS. 2A-2B shows a schematic representation of another example of a defect inspection system 200 based on a DIHM configured in reflection mode. It is very similar to the transmissive DIHM configuration, and is suitable for testing a coated reflective surface (e.g., a mirror). Most of spatially coherent light (represented in dotted line) from a source reflects off the reflective test surface (TS) and arrives at a detector array with minimal scattering. This constitutes the reference wave. Light from each defect in the reflective coating, e.g., a flat surface defect illustrated in FIG. 2A, or on top of the reflective coating, e.g., a particle/debris with height above the TS illustrated in FIG. 2B, creates a separate wavelet that interferes with the reference wave at the detector array. An image I-TS′ (or I-TS″) of the test surface is acquired by the detector array. In this manner, an interference pattern IP′ (or IP″) included in the acquired image I-TS′ (or I-TS″) carries information about defects in or on top of the reflective coating of the test surface that have influenced the spatially coherent beam as it reflected off the test surface.

Note that the reference and scattered waves in the reflective configuration of the defect inspection system 200 are “in line” and are not tilted with respect to each other like reflective Michelson interferometer configurations used in some conventional defect inspection systems. This minimizes the need for additional optics (PBS cube, reference mirror, etc.) in the optical path of the defect inspection system 200 that typically cause additional background artifacts during acquisition of the image I-TS′ (or I-TS″) of the test surface. Also note that the reflective configuration of the defect inspection system 200 shown in FIG. 2 provides maximum defect detection sensitivity compared to reflective configurations of conventional defect inspection systems. For most defects, the defect differential scatter cross-section is maximized in the specular reflection direction. Conventional microscopes cannot take advantage of the geometry shown in FIGS. 2A-2B due to the Schiempflug angle, and the inability to separate the main specular illumination beam from the scattered defect signals.

The same algorithmic processing that is used for the transmissive configuration described above in connection with FIG. 1 is also used by an electronic control module of the defect inspection system 200 (not shown in FIG. 2) to detect and characterize the defects on or in the reflective test surface based on the image I-TS′ (or I-TS″) of the test surface.

FIGS. 2A-2B depict detection of two types of defects illuminated in reflection mode at an angle of incidence θᵢ. For the flat defect shown in FIG. 2A, incident irradiance, I₀, is spread over the surface of the defect and over the defect-free region around it. As a consequence, the incident irradiance on the test surface plane is I₀ cos(θᵢ). For the purposes of this discussion, the lens-less DIHM in reflection mode of the defect inspection system 200 represents a simple imaging system with magnification, M. An area of the test surface that is imaged by each pixel of the detector array is given by

Aₚᵢₓ/M² cos(θᵢ), (1)

where Aₚᵢₓ is the effective area of the pixel at the detector array surface. The incident light will be reflected from the defect-free background surface with reflectivity R_{background}(θᵢ), which is essentially the Fresnel reflected optical power coefficient of the test surface. The reflectivity from the surface of the defect, R_{defect}(θᵢ) will depend on a number of factors. If the defect material is highly absorbing at the operating wavelength, then R_{defect}(θᵢ) will be relatively constant as a function of θᵢ. However, if the defect is a relatively flat surface scatterer that is optically rough (e.g., μᵣₘₛ>1), the defect will appear smoother as the angle of incidence is increased due to micro-surface shadowing effects. As a consequence, the reflectivity of flat, scatter-dominated debris and defects should increase (exhibit less scatter-based attenuation) with increasing angle of incidence. This means that the defect signal (the absence of light) will decrease with increasing angle of incidence. Equivalently, a brightness of the defect increases or a dimness of the defect decreases. Note that this is not the case for the debris shown in FIG. 2B. In this case, the debris is a particle that has a depth that is about equal to its lateral size. For this defect, the defect signal (absence of light) will not change much as a function of angle due to its depth and symmetry. Here, the defect brightness, or equivalently the defect dimness, remains substantially constant.

In addition to the dependence of the signal strength on the angle of incidence, the lateral defect size can also be used to determine whether it is flat or has depth. For the flat defect shown in FIG. 2A, the size of the defect will decrease in the tilt direction by cos(θᵢ), whereas the image of the blob defect shown in FIG. 2B will not undergo an apparent change in size. By combining this dimensional information with the angular dependence of the signal strength, the defect inspection system 200 based on a DIHM configured in reflection mode can provide information for determining the characteristics and the probable identity of a defect.

Additional information about the defect identity can also be obtained by employing a plurality of wavelengths when using the defect inspection system 200 based on a DIHM configured in reflection mode. The absorption, reflectivity, and scatter properties of different materials will vary, providing another indicator of defect identity. As known in literature, bidirectional reflection distribution (BRDF) for weak scattering surfaces with no material property effects is

BRDF˜(1/λⁿ)S(|sin(θ_{S})−sin(θᵢ)|/λ), (2)

where S is a function of spatial frequencies, the latter expressed here in terms of the scatter angle θ_{S} and the incidence angle θᵢ. The exponent n in Equation (2) is 4 for topographic and thin columnar defects, 3 for interference and random bulk defects, and 2 for thick columnar defects. Equation (2) indicates that, in general, the wavelength dependence of the scatter—away from the specular reflection angle—decreases as the surface roughness increases. As further known in literature, the BRDF for randomly rough isotropic surfaces is independent of wavelength. As such, as the surface features become large compared to the wavelength, they are essentially equivalent to microscopic reflectors that are dominated by geometric reflection rather than diffraction.

In summary, defects that are dominated by scatter physics should have a wavelength dependence that is large when the defects have surface roughness features that are smaller than the source wavelength. The wavelength dependence should be small for defects that contain scatterers that are large compared to the wavelength. However, not all defects will be dominated by scatter physics. Some debris may be composed of organic materials that may absorb one wavelength more than another as the light penetrates the outer surface of the debris. In order to maximize defect identification accuracy, a defect inspection system 200 based on a DIHM configured in reflection mode can utilize a combination of angle and wavelength to identify and classify defects.

Based on the above aspects, an algorithm for defect classification can be established based on the basic defect shape, defect morphology, reflected angle dependence, and wavelength dependence of the illuminating source light. Table 1 summarizes the expected defect discrimination results for several types of defects, and represents a basis for a defect discrimination algorithm.

TABLE 1

| Shape | Edge | IAR | SR | x: λ^{-x} | Classification |
|---|---|---|---|---|---|
| Line | Smooth | >1 | — | 3-4 | Scratch, low roughness |
| Line | Smooth | >1 | — | 0-3 | Rough scratch, λ^{-x} level |
| Line | Smooth | =1 | — | <0 | Organic debris |
| Line | Smooth | ≠1 | — | <0 | Organic structured debris |
| Line | Rough | =1 | — | <0 | Organic fiber |
| Line | Rough | ≠1 | — | <0 | Organic structured fiber |
| Point | Smooth | Any | Max | <0 | Organic debris, flat |
| Point | Smooth | Any | 1 | <0 | Organic debris, round-ish |
| Point | Smooth | >1 | Max | >0 | Bubble exposed during polish |
| | and | | | | |
| | round | | | | |
| Point | Well | >1 | Max | ≧0 | Micro-roughness pit not |
| | defined | | | | polished out |
| Point | Rough/ | =1 | 1 | ≧0 | Blob of absorptive debris |
| | mottled | | | | |
| Area | Rough/ | =1 | Max | Any | Possible stain or finger print |
| | mottled | | | | |
| Area | Rough/ | >1 | Max | ≧0 | Micro-roughness |
| | mottled | | | | |

In Table 1, IAR is the incidence angle ratio, SR is the size ratio, both low-to-high angle. Due to the complexity of the scatter and absorption processes and the variety of real defects that can be encountered on a test object, a defect discrimination algorithm may not be 100% accurate on an individual defect basis. In some implementation, a more achievable goal is to provide defect classification probabilities which enable the user to selectively ignore some classes of debris, and to provide defect trend information that can help the user improve the user's processes.

As part of a first experiment, cleanable and non-cleanable defects (scratches, digs, slurry rings, and debris) were imaged using the defect inspection system 200 illustrated in FIGS. 2A-2B operating at 405 nm. An adjustable angle of incidence was used enabling measurements at both 25 and 45°. The test objects were fused silica flats and sapphire wafers. Since the uncoated glass was very thin (<0.5 mm), 3 images were formed for each defect that was located on the top surface closest to the camera. Only one image is formed for each defect on the side facing away from the camera. Table 2 lists the power ratios for four defects that were recognizable as the same defect on both maps. The center defect was analyzed for each defect triplet.

TABLE 2

| Defect ID | Defect Type | Signal Ratio | Size Ratio |
|---|---|---|---|
| A | Debris | 0.9 | 1.3 |
| B | Debris | 1 | 0.9 |
| C | Slurry ring | 2 | 1.4 |
| D | Debris | 1 | 1 |

The following points can be made about the results in Table 2. Based on the cosine ratio between 22° and 45°, it is expected that the size of a flat defect decreases in width along the direction of tilt by a factor of 1.3×. This ratio will decrease as the depth-to-width ratio decreases. Based on its morphology, defects C was identified as a slurry ring. Slurry rings are formed when a drop of liquid with slurry particles dries, depositing particles around the edge of the drop. Slurry rings can be cleanable, but slurry material can sometimes etch into the surface, leaving a non-cleanable ring. Based on the size ratio (1.4×), this slurry ring is essentially flat. It also exhibits a power ratio of 2, indicating that it may be an optically rough scatterer (as opposed to an absorber). Defect A also has a size ratio of 1.3, indicating that it is probably flat. Its power ratio is close to 1, therefore it is probably highly absorbing and not a scatterer. Defects B and D probably have a nearly 1:1 height-to-width ratio since their size ratios are nearly equal to 1. They may also be highly absorptive since their intensity ratios are 1. As can be seen in Table 2, variable incidence angle does provide some potentially useful defect discrimination/classification information.

As part of a second experiment, cleanable and non-cleanable defects (scratches, markers, point defects and debris) were imaged using the defect inspection system 200 illustrated in FIGS. 2A-2B sequentially operated with source light at 405 nm and at 1060 nm. Incident angles were 22 and 30 for source light at 405 nm and at 1060 nm, respectively. Table 3 shows the (405 nm/1060 nm) signal ratios, with a value greater than 1 indicating that the defect is more absorbing or scattering at 405 nm than at 1060 nm.

TABLE 3

| Defect ID | Defect type | Signal Ratio |
|---|---|---|
| 1 | Red marker | 1.8 |
| 2 | Point defect | 1.4 |
| 3 | Scratch | 1.2 |
| 4 | Point defect | 1.8 |
| 5 | Point defect | 1.9 |
| 6 | Point defect | 2.35 |
| 7 | Large debris | 1 |
| 8 | Point defect | 1.3 |
| 9 | Point defect | 1 |
| 10 | Scratch | 3 |
| 11 | Sea horse shaped debris | 1 |
| 12 | Point defect | 1.8 |

In Table 3, the defects with a wavelength signal ratio of 1 are either very rough, or absorb equally at both wavelengths. The large debris fit into this category. The red marker is also more highly absorbing at 405 nm, as expected, since red ink is essentially a blue absorbing polymer. One of the scratches as well as several of the point defects exhibit signal ratios much greater than 1, possibly indicating that these defects have less roughness than the defects that have ratios closer to 1.

FIG. 3 is a flow chart of a process 300 for detecting defects located at one or more surfaces of the test object (lens or wafer). For example, the process 300 can be used by the electronic control module of the defect inspection system 100 or 200 to process an acquired image of the test object. The image of the test object includes an interference pattern formed from (i) a spatially coherent light that transmits through, or reflects from, the test object without being scattered, and (ii) source light that is scattered by the one or more defects on or in the test object. For clarity reasons, the process 300 is described below in conjunction with the defect inspection system 100.

At 310, (i) an effective distance z_{LS} between the multi-element detector and the light source, and (ii) an effective distance zⱼ between the multi-element detector and a surface Sⱼ of the test object are computed for a current field of view (FOV). In some implementations, the given surface is the exit surface S_{N} (the surface of the test object nearest to the multi-element detector).

The computation of the effective distances z_{LS}, zⱼ is performed based on a prescription (index, thickness, radius of curvature (ROC), dimensions) of the test object. In some implementations, the user enters the test object prescription into the electronic control module. In some implementations, the electronic control module retrieves at least a portion of the prescription information from a local or network data repository.

The electronic control module then performs an optical ray trace through the test object to calculate the effective distance z_{LS} between the multi-element detector and the light source and distance zⱼ between the multi-element detector and a surface Sⱼ of the test object for the current FOV. These computed effective distances are then used to calculate the effective magnification across the current FOV. A magnification value is used to calculate the sizes of the defects that are detected in the current FOV.

At 320, an acquired image I-TO of the test object is pre-processed. In some implementations, the intensity of the acquired image I-TO can be multiplied by a complex reconstruction wave, as described, for example, in Joseph W. Goodman, Introduction to Fourier Optics, 1968, e.g., at pp. 214-218, and in Chapters 3, 4, and 8. This provides considerable control over the magnification of a reconstructed hologram, but may add considerable computational load to the electronic control module. The reconstructed hologram represents the result of the pre-processing of the acquired image I-TO at 320, and is also referred to as the preprocessed image. In other implementations, the preprocessed image is generated by taking the square root of the intensity image I-TO, to simulate the field magnitude, and by setting the imaginary part of the field to zero. Non-uniformity in the acquired image may also be corrected during this pre-processing step.

At 330, back propagation for each reconstruction plane of interest on and within the test object is performed using the preprocessed image to generate one or more of an electric field (e-field) amplitude map, e-field phase map, or an intensity map associated with the reconstruction plane. In general, back propagation can be performed using conventional back propagation techniques, as described, for example, in Kim, Myung K., “Principles and techniques of digital holographic microscopy”, SPIE Reviews, 018005-1, Vol. 1, 2010.

In some implementations, the Angular Spectrum Method is used to perform the back propagation at 330. Other back propagation techniques can be used. These include, but are not limited to, Fresnel transform, Huygens convolution methods, or some combination of these methods.

In the example illustrated in FIG. 1, reconstruction planes of interest are the planes at distances z_{N}, zⱼ, zᵢ and z₁ which correspond to the exit surface S_{N}, the internal surfaces Sⱼ, Sᵢ, and the entry surface S₁. Additionally, the generated maps corresponding to the reconstruction planes of interest are the planes at distances z_{N}, zⱼ, zᵢ and z₁ are shown in FIG. 1 as the images I-S_{N}, I-Sⱼ, I-Sᵢ and I-S₁, respectively.

In some implementations, the back propagation distance to the desired focus plane of interest can be adjusted by the user to the plane of interest, which can be, for example, the front surface of the optic, the back surface, or an intermediate plane within the optic where a cement layer, PBS hypotenuse, bubble, occlusion, coating void, or other defect of interest may be located. In the example illustrated in FIG. 6, the user can use a GUI to specify the back propagation distance. In this manner, the user can “scan” the back focal distance through the optic, quickly looking for defects throughout the optic based on one camera frame, without having to move any optics. Referring again to FIG. 3, the electronic control module can perform an automatic scan of many image reconstruction planes throughout the optic, automatically locating all of the defects of interest throughout the test object for each selected camera frame field-of-view.

At 340, twin artifact reduction for the map(s) corresponding to each reconstruction plane can be optionally performed. Twin artifacts may be present in the reconstructed image when using the DIHM in-line configuration. These artifacts appear as residual bulls-eye rings around defects and are a result of missing phase information when converting the captured pre-processed image to the initial electric field map. Twin artifact reduction may be incorporated into a user interface for cases where the user is presented with a raw image of the defects for direct review. In this manner, the user may instruct the electronic control module whether to perform twin artifact reduction, and if so which algorithm to apply.

In some implementations, twin artifact reduction for amplitude-only or phase-only maps is performed based on an iterative phase retrieval processing, as described, for example, in Liu, G., Scott, P. D., “Phase retrieval and twin-image elimination for in-line Fresnel holograms”, JOSA A, Vol. 4, #1, January 1987.

In some implementations, multiple images I-TO, I-TO′, . . . can be collected while moving the multi-element detector in the Z direction (along the optical axis). These images can be processed using conventional image processing techniques as described, for example, in Pedrini, G., Osten, W., and Zhang, Y., “Wave-front reconstruction from a sequence of interferograms recorded at different planes”, Optics Letters, Vol. 30, No. 8, Apr. 15, 2005 to obtain an improved image of the defect with a reduced twin artifact. For example, multiple images I-TO, I-TO′, . . . are collected while moving the multi-element detector in the Z direction (along the optical axis). Each of the images I-TO, I-TO′, . . . is then back-propagated, in accordance to 330, to the physical plane of interest Pⱼ. The back-propagation distance zⱼ, zⱼ′, . . . will be different for each of these images I-TO, I-TO′, . . . in order to back-propagate to the same physical plane Pⱼ. All of the back-propagated images are then simply averaged together to suppress the twin artifact.

At 350, flaws in the map(s) corresponding to each reconstruction plane are detected. For instance, a histogram can be calculated for at least one of the propagated images within the current FOV. Based on the calculated histogram, a threshold value is determined. The determined threshold value is applied for each reconstruction map within the current FOV. Pixels that produce values beyond the threshold value (either above or below it, depending on the “polarity” of the image) are then grouped together to form individual entities called “flaws”. The flaws correspond to the defects of the test object. Since most optical defects appear opaque in the DIHM optical configuration, the defects appear dark or black, therefore pixels that fall below the threshold are detected as defects. Areas that do not produce secondary defect-induced wavelets appear as a uniform bright background region in the image. Defect pixels are grouped together and connected where they are contiguous in accordance with connectivity rules.

At 360, flaw map(s) corresponding to each reconstruction plane are generated for the current FOV. Additional processes of the flaw map(s) for the given FOV of the test object are described below in connection with FIG. 11. Other additional processes of flaw maps corresponding to multiple FOVs of a scanned test object are described below in connection with FIG. 17.

FIG. 4 shows that the defect inspection system 100 can be used in accordance with the process 300 for single-shot detection of defects on the entry and exit surfaces and on the hypotenuse surface of a PBS cube.

When testing a PBS cube, one may be interested to detect contamination, scratches, digs on the front surface S_{N} and back surface S₁, throughout the glass for bubbles, and specifically along the 45 degree hypotenuse surface HS for coating voids. For instance, an image I-(PBS cube) of the PBS cube can be acquired by the multi-element detector. Once again, the image I-(PBS cube) is formed from a combination of the portion of the spatially coherent beam that transmits through the test object with minimal scattering and the scattered beam. In this manner, an interference pattern (IP′) included in the acquired image I-(PBS cube) carries information about all the defects (regardless of whether they are located on the entry or exit surfaces, S₁, S_{N}, or inside the volume, for example on the hypotenuse surface HS) of the PBS cube that have influenced the spatially coherent beam as it transmitted through the PBS cube.

In this example, the electronic control module is configured to run in PBS cube mode to provide individual defect maps for a) the individual front and back surfaces S_{N}, S₁ based on the electric field magnitude or intensity; b) a defect map for the diagonal hypotenuse surface HS that is derived from the many individual reconstruction surfaces corresponding to the PBS cube's surfaces S₁, . . . , Sᵢ, . . . , Sⱼ, . . . , and S_{N}, such that the individual reconstruction surfaces corresponding to the hypotenuse surface HS use the electric field phase rather than magnitude; and c) a map showing the bubbles in the glass along with their axial and lateral locations (also based on the electric field magnitude or intensity).

In the example illustrated in FIG. 4, an image I-S_{N} of the electric field amplitude corresponding to the exit surface S_{N} of the PBS cube shows a non-cleanable (NC) defect D₃ that can be discriminated from the background since it completely blocks the incident light. An image I-S₁ of the electric field amplitude corresponding to the entry surface S₁ of the PBS cube shows a debris particle D₁ that is semi-transmissive but has clean edges.

A composite image I-HS of the electric field phase corresponding to the hypotenuse surface HS of the PBS cube shows coating voids (e.g., D₂ is one of the multiple coating voids detected on the hypotenuse surface HS). In this composite image I-HS, multiple sub-regions of the hypotenuse surface HS are brought into focus using multiple back propagation distances z₁, . . . , zᵢ, . . . , zⱼ, . . . , z_{N} to obtain a composite, in-focus image I-HS of the angled hypotenuse surface. The composite image I-HS is generated by combining in-focus portions of each of the generated phase images P(I-Sⱼ) corresponding to the associated surface Sⱼ, in the following manner: I-HS=P(I-S₁)+ . . . +P(I-Sᵢ)+ . . . +P(I-Sⱼ)+ . . . +P(I-S_{N}). The in-focus portion of a phase image P(I-Sⱼ) corresponding to a surface Sⱼ represents a portion of the I-Sⱼ image that is centered on an intersection line between the hypotenuse surface HS and the surface Sⱼ.

In this example, the defects detected in the composite image I-HS appear to be coating voids since they are not completely non-transmissive like particles would be. In this manner, the defect inspection system 100 can simultaneously detect and analyze defects on the front, back, and along the complete hypotenuse of finished cube splitters.

FIG. 5 shows an example of an implementation of a defect inspection system 500 based on a DIHM system in transmission mode. FIG. 6 shows another example of an implementation of a defect inspection system 600 based on a DIHM system in transmission mode for high resolution defect detection. A large class of test objects can be inspected using this mode, such as transparent windows, flats, PBS cubes, wave plates, lenses, prisms, and semi-transparent glasses such as ionically-implanted filter glass.

In analogy with the defect inspection detection system 100 described above in connection with FIG. 1, the defect inspection system 500 includes a) a light source with a relatively high spatial coherence but, preferably, a relatively low temporal coherence, b) electronic circuitry for driving the laser (optionally under computer control), c) a digital camera equipped with a 2D focal plane detection array, preferably with a high pixel count (e.g. >1K×1K), where the digital camera is connected to a computer that transfers the images into a digital computer, d) a polished, transparent test object positioned between the source and camera, e) algorithmic computer software for processing the image to extract the desired scratch/dig information from one or more of the image reconstruction planes located on or within the test object based on the diffractive intensity patterns present in the acquired image, f) hardware and/or software processing devices for detecting and classifying the defects into binned types (point, area, line, size, and morphological characteristics), g) hardware and/or software processing devices for analyzing these binned/classified defects to present to the user an overall scratch/dig specification for the test object, and optionally, a pass/fail indication for the production test object based on this composite scratch/dig measurement, and h) a display device for presenting all of this information to the user in a “live”, graphical manner.

In some implementations, the light source can be a laser diode configured with controllers for modulating the wavelength by modulating either the current or temperature. The modulation can be fast relative to the camera frame integration time, thereby effectively creating a relatively broad wavelength spectrum that (lowers the time coherence of the light source and, thus) reduces the background coherent speckle structure and mottle from the multiple test object surfaces. This lowers the spatial background noise and improves the detection of localized defects.

A laser diode is modulated by modulating either the current or the temperature during the camera acquisition frame time (or period). Laser current modulation can be done very fast relative to the camera frame time, and can be used to produce many wavelengths during normal camera acquisition times, which are typically in the 100-1000 microsecond range for a typical 405 nm laser diode and a typical CCD camera. The temperature of the laser diode can also be modulated, however. The wavelength range that can be achieved is much larger when using temperature modulation, but it is much slower than diode current modulation. As a result, multiple frame averaging is performed prior to back propagation when using the thermal modulation method.

Laser diode sources that can be used include VCSEL's, Fabry-Perot laser diodes, and external cavity lasers.

In some implementations, the temporal coherence of a laser diode is reduced by operating it below its specified lasing threshold current. In some implementations, a superluminescent diode (SLD) may also be used to provide even wider bandwidths compared to that of laser diodes that are operated below threshold.

In some implementations, the temporal bandwidth of the source can be effectively increased by collecting multiple camera frames while operating the source at different wavelengths corresponding to each frame. The frames are averaged together to create one composite frame with lower spatial noise. It is important to note that standard laser diode packages usually contain a window that produces unwanted spurious diffractive patterns, therefore it may be removed, modified, or replaced to mitigate this problem.

Finally, an LED and a small (˜10 micron) pinhole spatial filter can also be used to provide a low temporal coherence with high spatial coherence. However, radiance of this source is usually significantly lower than that of a laser diode.

In some implementations, the camera may be electronically shuttered to prevent fringe motion due to vibration. A camera with a large number of pixels can capture as much defect area as possible. In some implementations, the cover glass is removed to eliminate the associated mottle structure and defect artifacts. If a cover glass is used, it should be AR coated and polished to minimize surface roughness and should be kept extremely clean using pressurized air or routine cleaning intervals. The camera frame rate and the data processing time determine the overall system throughput and processed display update rate.

The lateral and longitudinal optical resolution of a DIHM/DHM configuration like the ones shown in FIGS. 5-6 is controlled by the numerical aperture (NA) of the detection system. The effective detection NA for these configurations is approximated by

NA=(W/2)[(W/2)²+L²]^{-1/2}, (3)

where L is the distance from the laser diode to the camera, and W is the width of the camera sensor. The lateral and longitudinal optical resolution can then be calculated from the NA using

D_{X}=λ/(2NA) (4)

and

D_{Z}=λ/(2NA²), (5)

respectively. As the camera width increases, the detection NA increases, thereby enabling the instrument to detect higher defect wave angles and fringe frequencies, and to resolve smaller lateral and longitudinal features. The camera pixel size and spacing sets an upper Nyquist sampling limit on the fringe density that can be detected in the defect bulls-eye tails. This can be overcome by moving the defect plane closer to the laser, thereby increasing the magnification of the setup and increasing the size of the bulls-eyes on the camera relative to the pixel spacing. The magnification as well as the Back Propagation Imaging Distance (BPID) of the focused image has been formally derived and adapted for the defect inspection system 500 shown in FIG. 5. The magnification, M, is defined by the hologram production geometry, and is given as

M=L/z, (6)

where z is the distance between the laser and the test surface to which back propagation will be performed. Note that this magnification factor assumes that the reconstruction wavelength is the same as that of the illumination, and that the reconstruction source is located at infinity (plane wave reconstruction). The BPID is given by

BPID=(L/z)(L−z) (7)

The source NA must match the detection NA defined in Equation (3) in order to provide relatively uniform illumination across the camera and to make use of the available detection NA. For some sources, it may be necessary to add an NA-boosting negative lens at the laser diode or fiber end. This may introduce additional artifacts into the image, however, since this lens must be free of defects and extremely clean. A custom, high NA fiber should be considered since this would eliminate the cosmetic issues associated with a negative NA-booster lens.

Increasing the NA of the source and camera detection geometry also reduces the irradiance per camera pixel. The exposure time of the camera must be increased to compensate for this effect, resulting in greater sensitivity to leakage of room light into the instrument and sensitivity to motion when performing a multiframe test part scan.

In light of Equations 1-5, there are many parameter permutations to consider when designing a system around DIHM/DHM technology. The minimum market and system requirements/goals should be defined before embarking on this system trade-off analysis.

The effective detection NA of the instrument can be increased by a) increasing the size of the camera, or by b) physically moving one or more cameras to multiple positions while capturing frames to create a combined mosaic tiled image. FIG. 6 shows a defect inspection system 600 in which the latter method was implemented. This significantly increases the magnification and resolution of the defect inspection system 600 relative to the defect inspection system 500, providing increased defect sensitivity.

Moving the test part away from the camera and toward the laser diode has the effect of increasing the size of the bulls-eye patterns and increasing the magnification by at least 4×. The tiling-based system 600 has a substantially improved lateral optical resolution compared to the single frame case system 500, reducing it from 4 μm to less than 1 μm. In addition, the longitudinal optical resolution was reduced from 80 to 10 μm. The back propagation distance to the focus position increased from 5.4 to 185 mm for the tiled configuration 600 compared to configuration 500. Note that the BPID and the physical distance are nearly the same when the defect plane is close to the camera, but they dramatically diverge as the defect plane is moved closer to the laser diode and away from the camera. The controls for the back-propagation code were modified to handle this effect. The tiled mosaic back propagation code is accessed through the Scratch/Dig Analysis button of the GUI illustrated in FIG. 6.

FIG. 7 shows an example of a camera tile pattern 700 used in the DIHM system of FIG. 6. This example of camera tile pattern is used to create 3200×3600 pixel mosaic image. FIG. 8 shows a tiled image 800 generated using the image tiling pattern of FIG. 7. In this case, the image 800 is a tiled 3200×3600 image of a polished flat. The blue laser diode of the defect inspection system 600 was oriented along one of the diagonal directions across the camera, therefore the intensity roll-off was acceptable in this direction, but it drops off too fast in the perpendicular direction. A negative NA-boosting lens can be used to correct this problem. Some of the magnified bulls-eyes in the tiled image 800 are so large that they cross over tiled image boundaries. These may have been missed if the image were acquired with the lower resolution defect inspection system 500.

FIGS. 9A-9B show aspects of a defect detected on the entry surface of the polished flat using the tiled image of FIG. 8. FIG. 9A shows a zoomed image 910 of a 14×18 micron defect at 2750, 1600 coordinate of the tiled image 800. FIG. 9B shows a slice 920 through the defect; in this example the effective inspection resolution is 0.6 μm/pixel.

FIGS. 10A-10B show aspects of a defect detected on the exit surface of the polished flat using the tiled image of FIG. 8. FIG. 10A shows a zoomed image 1010 which illustrates multiple defects (BPID=172 mm, Mag=4.2×). The small defects are ≦10 μm in diameter; in this example the effective inspection resolution is 1 μm/pixel. FIG. 10B shows a slice 1020 through pixel column 2392; the defect at row 490 is <10 μm wide; in this example the effective inspection resolution is 1 μm/pixel.

As described in FIGS. 8-10, the defect inspection system 600 enables high resolution defect inspection. Accordingly, the detected defects can be characterized with high precision and classified with high accuracy.

FIG. 11 is a flow chart of a process 1100 for classifying defects detected using a defect inspection system. For example, the process 1100 can be performed by the electronic control module of the defect inspection system 600 described above in connection with FIG. 6. Moreover, the process 1100 can be performed after performing the process 300 on flaw map(s) generated for a current FOV of a test object.

At 1110, flaws in flaw map(s) corresponding to each reconstruction plane for the current FOV are characterized by calculating their aspect ratio, orientation, area, edge roughness, opacity, circularity, and other parameters.

At 1120, defects are classified into their flaw types (dig, scratch, bubble within the material, or area defect, such as a fingerprint or stain) using the flaw characteristic parameters. In some implementations, the defects can be further classified based on additional characteristics such as opacity, edge roughness, phase characteristics, etc. using morphological processing methods, as is known in literature. Finally, the complete information for each defect can then be used to generate a probabilistic determination of its physical type (fiber, surface particles, scratches, bubbles, surface bubble break-through, digs, coating voids, etc.), and the probability that it can be cleaned and removed. This classification process is generally not perfect for real defects. Therefore, a probabilistic methodology is most appropriate for indicating the likelihood that a defect belongs to a particular category.

At 1130, the defects are represented in a final flaw map for a given FOV of the test object and are binned by defect type. These results can be displayed on a binned scratch/dig defect display. Once all of the defects and their measured characteristics are known, the defects can be binned by size and type, and a user-defined “recipe” is then applied for a final pass/fail determination.

FIG. 12 shows an example of a GUI that is used to display defect classification in the defect inspection system of FIG. 6. In some implementations, the GUI can be configured to present to a user an overall scratch/dig specification for the test object, and optionally, a pass/fail indication for the production test object based on this composite scratch/dig measurement. In some implementations, the flaws on the defect map are color-coded to match the color associated with the bin to which they belong. For example, scratches may be colored red, digs in the 100-200 micron range color blue, bubbles green, and so on. In some implementations, the positions and orientations of the flaws are drawn on the screen to show where they are located. In some implementations, when the user indicates a defect, a tool-tip is displayed showing the pertinent data associated with the defect (Z position, sizes, aspect ratio, opacity, etc.). In some implementations, a pass/fail indicator also is displayed. The GUI can utilize a tabbed interface architecture to access supervisory setup controls and additional statistics.

Several examples of defect types detected using the disclosed technologies are described below.

FIGS. 13A-13C show images of scratch defects on a standard scratch/dig paddle that is routinely used for comparative human visual qualitative inspections in according to MIL-PRF-13830B. FIG. 13A shows an electric field magnitude image 1310 of a #20 scratch on the scratch/dig paddle. FIG. 13B shows an electric field magnitude image 1320 of a #10 scratch on the scratch/dig paddle. FIG. 13C shows an electric field phase image 1330 of the #10 scratch on the scratch/dig paddle. The #10 scratch appears to be more visible in the field phase than the field magnitude.

The image of the standard scratch/dig paddle, from which the electrical field amplitude and phase images in FIGS. 13-A-13C are generated, was acquired using illumination from a 637 nm laser diode. The laser diode was effectively operated as an SLD by running the current near the threshold to reduce the longitudinal coherence. Note that the background mottle structure is NOT from the defect detection system—it is an artifact of the polymeric paddle and is not typical of most optical glass.

FIG. 14A shows an image 1410 of a hard, non-cleanable (NC) defect in the optical surface of a lens. “Hard” defects with high opacity and sharp edges tend to produce sharp phase transitions along the back propagation direction.

FIG. 14B shows an image 1420 of a soft cleanable debris on the surface of the lens. Partially transmissive “soft” defects with rough edges tend to produce more gradual phase transitions. Phase evolution can be combined with opacity and edge smoothness at the plane of best focus to compute a hard/soft defect classification factor.

FIG. 14C shows an image 1430 of a dig (circled) in the surface of an aspheric lens surface. The opaque region at the end of the dig suggests that it was formed by a particle that was dragged along by the machine tool. The other two defects shown in the image 1430 are debris. The machining swirl marks are also clearly seen in the image 1430.

FIGS. 15A-15C show aspects of another implementation of a defect inspection system 1500 based on a DIHM in transmission mode configured with lateral-rotational scanning for defect detection of non-planar (e.g., spherical) objects. The defect inspection system 1500 further expedites the inspection process by automating the movement of the inspection head (including the camera and the light source) relative to the test object. In this case, the user would simply load the test object into the defect inspection system 1500, and then the defect inspection system 1500 would automatically scan the surfaces and display the scratch/dig information described above for all of the surfaces of interest without the need for user interaction. In the process of laterally scanning a test object, the test object is moved, and the inspection head is stationary. For small parts, it is desirable for this automated inspection process to take no more than a few seconds per part for practical production operation.

In some implementations, for inspection of spherical surfaces with steep surface slopes (about >45 degrees), the camera rotates on an arm that pivots at a point that is located at the center of a circle whose radius is the radius of the surface under test. This pivot point location and the camera arm length are configured to be adjustable to accommodate various lens radii. FIG. 15B shows a stepped scan pattern for inspecting a circular lens. The lens spins around its optical axis, which is also the axis of rotation. Camera frames are captured and processed as the lens spins and the camera arm rotates 90 degrees from the edge of the lens to the axis of rotation, thereby mapping the defects on the spherical surface of the lens. FIG. 15C shows a stepped scan pattern for inspecting a circular flat. For flats, the camera arm is rotated so that the camera is pointed along the axis of rotation and then locked into this position. The optic is then translated from the center to the edge as it is rotated. Camera frames are captured and processed to produce a defect map.

The laser assembly is mechanically linked to the camera, and is always pointed so that the laser beam is propagated toward the camera and is aligned to the optical axis of the camera to produce a symmetrically-distributed illumination distribution. The distance between the laser and camera should be adjustable to accommodate various test object sizes and prescriptions. The camera-to-laser separation distance, CL, could be manually set by a user to a distance recommended by the system, or automatically set via a motorized stage.

In implementations shown in FIG. 15A, the laser/camera rotational arm assembly is mounted to a rotational theta stage that is then mounted to stacked X-Y translation stages. The laser/camera rotational arm assembly rotates around the pivot that is located at the center of a circle whose radius is the radius of the test surface. FIGS. 15B and 15C depict stepped scan patterns across a lens and a circular flat, respectively. When testing the curved surface of a lens, the X-Y stages position the theta stage so that its axis of rotation aligns with the optical axis of the lens. A scan is performed by capturing images while stepping through a sequence of laser/camera rotation arm angles and theta stage angles. For flat testing, the laser/camera rotational arm is rotated to its vertical position so that it is perpendicular to the flat surface of the test piece. The X-Y stage then steps through all of the X and Y positions necessary to scan the part. For cylinder lens inspection, the arm is stepped through rotation angles while moving only the Y axis. This provides coverage for one half of the lens. The theta stage can then be rotated 180 degrees to inspect the other half of the cylinder lens.

In some implementations, simultaneous inspection of both lens surfaces is possible if the surface slopes are not too steep. Note that spherical lenses can be tested by XY raster scanning and stitching together the flaw maps from individual FOV's as long as the surface curvature sag is preferably less than about 45 degrees across a FOV, depending on the defect sizing accuracy requirements. This is achieved by using many intermediate reconstruction planes to collect a plurality of in-focus images across the curvature of the spherical lens surfaces. The sizes of the defects must be adjusted to compensate for the various view angles. Much steeper surface curvatures may require stitching using the rotating arm configuration that is described in connection with FIGS. 15A-15C.

FIG. 16 shows another implementation of a defect inspection system 1600 based on a DIHM in transmission mode configured with lateral scanning for defect detection of semiconductors objects. The defect inspection system 1600 is configured to perform NIR semiconductor inspection. For example, the defect inspection system 1600 can be used to detect defects at an interface between a Si-wafer and a glass wafer bonded to the Si-wafer. As another example, the defect inspection system 1600 can be used to detect defects at an interface between two Si-wafers bonded together.

The light source can be an IR laser operating at 1064 nm, for instance. Laser diodes which emit light having a wavelength of 1.3 μm, 1.55 μm all longer also can be used. In this manner, the illumination light provided by the light source will be transmitted through a Si wafer.

In some implementations, a temporally modulated laser diode can be used where the current or temperature is either a) modulated quickly relative to the camera exposure time, or b) multiple frames are captured and averaged during the current and/or temperature modulation, to increase the temporal bandwidth of the laser and thereby reduce the coherent artifacts. This technique enables operation of the laser diode near full power, which can be important for the NIR semiconductor defect inspection system 1600.

The defect inspection system 1600 can raster scan a wafer using XY stages. The stages used to perform the wafer raster motion may be designed to handle wafer sizes up to 450 mm in diameter. If only one magnification is required, the camera and laser/beam expander (BEX) assembly can be mounted in fixed positions. If variable magnification/resolution is desired, additional stages can be added.

The stage motors can utilize conventional controllers so that the same device drivers and controllers can be used for both the semiconductor defect inspection system 1600 and the optical scratch/dig defect inspection systems 600, 1500.

In other implementations, the defect inspection system 1600 may be based on a DIHM in reflection mode, in analogy with the defect inspection system 200.

FIG. 17 is a flow chart of a process for combining flaw maps of N-FOVs corresponding to a laterally-scanned test object. For example, the process 1700 can be performed by the electronic control module of the defect inspection systems 1500 or 1600 described above in connection with FIGS. 15A and 16, respectively. The maps correspond to the N-FOVs of the test object when it is scanned in the X/Y directions. Each FOV is then combined to create a defect map for the entire part.

At 1710, process 300 is performed for each of N-FOVs of a laterally-scanned test object to generate corresponding flaw maps. Optionally, at 1710, process 1100 can be performed to classify the flaw maps which correspond to the N-FOVs of a laterally-scanned test object.

At 1720, the generated flaw maps for each of N-FOVs are stitched together to form one final, composite flaw map of laterally-scanned test object by connecting flaws that cross FOV boundaries.

Optionally, the final composite flaw map is then binned by size and type and the results are displayed on a binned scratch/dig defect display, for example using the GUI 1200 described above in connection with FIG. 12.

FIG. 18 is a block diagram of an example of a system electrical architecture 1800 that can be used with any one of the inspection systems 100; 200; 500; 600; 1500; and 1600 described above in connection with FIGS. 1 and 4; 2A-2B; 5; 6, 15A; and 16. The system electrical architecture 1800 includes a custom control/interface board, a controller/preprocessor computer (or process thread, if using just one computer), a flaw processor computer (or thread), a defect map processor (or thread), and a GUI display.

The custom control interface board includes circuitry configured to interface with a laser diode, a thermo-electric cooler (TEC), a thermistor, a camera, and system motors. This board is configured to interface with the controller/preprocessor. The controller/preprocessor can send interface board commands and read back the interface board status values as well as read/buffer camera frames. The controller/preprocessor also can perform the back propagation processing at the desired back propagation distances, apply a threshold, and then pass the connected pixels associated with flaws along with their scan position locations to the flaw processor. The flaw processor is configured to apply morphological processing to identify defect types (point, area, line, as well as classification) and size of each defect. Final flaw information is then passed to the defect map processor to create and display a composite defect or flaw map on the GUI display. Rules are applied to the flaw map to determine if the optic passes or fails a desired customer specification recipe.

In some implementations, a defect inspection system 600, 1500, 1600 may also include an external pressurized air hose fitting. The pressurized air may be directed onto the optical surfaces to blow off loose debris from the surface. This debris should be exhausted out of the defect inspection system to avoid accumulation of dust on the multi-element detector and light source.

An ionizer can be used in conjunction with the pressurized air nozzle to eliminate the charge on the particles that are electrostatically attached to the optical surfaces, thereby improving the cleaning effectiveness of the pressurized air. Ionized air can damage the multi-element detector and light source of the defect inspection system, however, so they must be moved to a well-protected “park” position when the ionizer is on. Pressurized air without ionization can be provided to the multi-element detector and light source “park” positions to remove loose particles from the camera and laser windows.

Many more combinations and permutations of the disclosed technologies are also possible by judiciously applying digital holographic techniques to scratch/dig inspection problems. For example, a common path dual source technique can be used as a possible method for removing the twin image by additional optical hardware rather than algorithmic means and for obtaining additional defect classification information. A non-common path method version of this concept can also be used, whereby a beam splitter is added to the defect beam path between the test object and the camera, and the second fiber source is used to illuminate this splitter to provide a second, physically separate reference beam. This can be used to eliminate secondary images at the expense of additional splitter-induced artifacts. Reflective DIHM and DHM techniques may also be utilized for the measurement of scratches and digs on mirrors and other polished opaque surfaces.

In general, any of the inspection methods 300, 1100, 1700 described above can be implemented in hardware processors or software, or a combination of both. For example, in some embodiments, electronic control module (ECM) can be installed in a computer, the latter being a part of or connected to one or more defect inspection system 600, 1500, 1600. In this manner, the ECF can be configured to control the defect inspection system 600, 1500, 1600. The inspection methods 300, 1100, 1700 can be implemented in computer programs using standard programming techniques following the methods described herein. Program code is applied to input data (e.g., detected interference patterns) to perform the functions described herein and generate output information (e.g., classified defects and maps thereof, pass/no pass results, etc.) The output information is applied to one or more output devices such as a display monitor. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits preprogrammed for that purpose.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The computer program can also reside in cache or main memory during program execution. The inspection methods 300, 1100, 1700 can also be implemented as a computer-readable storage medium, configured with a computer program, where the storage medium so configured causes a computer to operate in a specific and predefined manner to perform the functions described herein.

While this specification contains many specific implementation details, these should not be construed as limitations on the scope of any technologies or of what may be claimed, but rather as descriptions of features specific to particular embodiments of particular technologies. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A system for determining information about one or more defects on or in a test object, the system comprising:
a light source configured to illuminate a test object with spatially coherent light;
a multi-element detector positioned to detect an interference pattern of light associated with one or more defects on or in the illuminated test object; and
an electronic control module in communication with the multi-element detector and configured to process the interference pattern to determine information about the one or more defects on or in the test object.

2. The system of claim 1, wherein the interference pattern is produced by the spatially coherent light that transmits through at least a portion of the test object without being scattered and source light which is scattered by the one or more defects.

3. The system of claim 2, wherein
the spatially coherent light transmits through a volume of the test object extending from an entry surface of the test object to an exit surface of the test object within a field of view of the multi-element detector, and
the one or more defects are on the entry surface, on the exit surface, or in the volume of the test object within or adjacent the field of view of the multi-element detector.

4. The system of claim 3, wherein the electronic control module is configured to
process the interference pattern to determine characteristics of the source light at two or more surfaces of the test object, the two or more surfaces comprising any combination of the entry surface, the exit surface, or one or more inner surfaces within the volume of the test object,
determine the information about the one or more defects from the determined characteristics, and
classify the one or more defects based on the determined information as one or more of (a) a scratch or dig of the entry or exit surfaces, (b) a void located inside the test object volume, and (c) debris located on the entry or exit surfaces or at one of the inner surfaces of the test object volume.

5. The system of claim 4, wherein
the test object comprises a prism, and
a first one of the two or more surfaces is a first surface of the prism and a second one of the two or more surfaces is a second surface of the prism which is at an angle with respect to the first surface of the prism.

6. The system of claim 4, wherein
the determined characteristics of the source light comprise two or more of amplitude, phase or intensity, and
the two or more surfaces are separated by distances larger than or equal to an axial resolution of the system.

7. The system of claim 1, wherein the interference pattern is produced by the spatially coherent light which reflects from at least a portion of the test object without being scattered and source light which is scattered by the one or more defects.

8. The system of claim 7, wherein
the spatially coherent light reflects from a test surface of the test object, the test surface being within a field of view of the multi-element detector, and
the one or more defects are on the test surface within or adjacent the field of view of the multi-element detector.

9. The system of claim 8, wherein the electronic control module is configured to
process the interference pattern to determine characteristics of the source light at the test surface of the test object,
determine the information about the one or more defects from the determined characteristics, and
classify the one or more defects based on the determined information as one or more of (a) a scratch or dig of the test surface, and (b) debris located on the test surface.

10. The system of claim 9, wherein the determined characteristics of the source light comprise two or more of amplitude, phase or intensity.

11. The system of claim 1, wherein the test object comprises one or more layers defined by any combination of transparent surfaces, semi-transparent surfaces, non-transparent surfaces, and reflecting surfaces.

12. The system of claim 11, wherein the electronic control module is configured to process the interference pattern to determine whether each of the one or more defects is a scratch or dig of one of the surfaces defining the one or more layers of the test object, and if so, determine on which one of the surfaces the scratch or dig is located.

13. The system of claim 1, wherein the determined information about the one or more defects comprises distances between the one or more defects and the multi-element detector.

14. The system of claim 1, wherein the electronic control module is configured to process the interference pattern to classify the one or more defects based on the determined information as one or more of (a) a scratch or dig of an entry or exit surface of the test object, (b) a void located inside the test object, and (c) debris.

15. The system of claim 14, wherein the electronic control module is configured to process the interference pattern to determine whether each of the one or more defects is a scratch or dig of an entry or exit surface of the test object.

16. The system of claim 1, wherein the system does not include any imaging optics between a mount that supports the test object and the multi-element detector.

17. The system of claim 1, further comprising a display configured to show a visual representation of the defects on or in the test object based on the interference pattern processed by the electronic control module.

18. The system of claim 1, wherein the spatially coherent light is in any of the ultraviolet, visible, near-infrared, or infrared regions of the electromagnetic spectrum.

19. The system of claim 1, wherein the light source is configured to produce the spatially coherent light with a temporal coherence low enough to substantially eliminate any contributions to the interference pattern besides those caused by the one or more defects on or in the test object.

20. The system of claim 19, wherein
the light source is configured to output multiple wavelengths of light,
the multi-element detector is configured to acquire instances of the interference pattern at two or more of the multiple wavelengths of light, and
the electronic control module is further configured to average the acquired instances of the interference pattern.

21. The system of claim 19, wherein the light source comprises a laser diode operated below a lasing threshold to provide the low temporal coherence.

22. The system of claim 19, wherein the light source comprises a superluminescent diode.

23. The system of claim 19, wherein the light source is an LED in combination with a pinhole to provide high spatial coherence with low temporal coherence.

24. The system of claim 19, wherein the light source is a laser diode having a laser cavity that can be modulated, and wherein the laser diode is configured to operate above a lasing threshold while its laser cavity is being modulated faster than an acquisition frame period of the multi-element detector to provide the low temporal coherence.

25. The system of claim 1, wherein the determined information comprises (i) location information including lateral and axial locations of the one or more defects of the test object volume, and (ii) morphological information thereof.

26. The system of claim 25, wherein the electronic control module is configured to process the interference pattern to classify whether each of the one or more defects is a scratch or dig of a surface of the test object based on the location information and the morphological information.

27. The system of claim 26, wherein the electronic control module
determines size and quantity of the classified one or more defects of the test object, and
provides an indication whether either
the determined size exceeds a target size, or
the determined quantity exceeds a target quantity, or
a combination of the determined size and quantity exceeds a target combination.

28. The system of claim 25, wherein
the determined information further comprises a representation of a surface at a given axial location of the test object volume where characteristics of the source light are estimated, and
the representation of the surface at the given axial location depicts at least lateral locations of defects of the test object volume located adjacent to the surface at the given axial location and morphological information thereof.

29. The system of claim 1, further comprising
a mount configured to move the test object laterally such that a second interference pattern is recorded by the multi-element detector, the second interference pattern corresponding to an adjacent portion of the test object, and
the electronic control module is configured to
process the second recorded interference pattern to determine information about additional defects on or in the test object,
generate a representation of a surface of the adjacent test object portion, and
stitch together the representations of the adjacent portions of the test object.

30. The system of claim 1, wherein
the multi-element detector comprises a mosaic of sensor arrays arranged with respect to the light source, such that one of the mosaic of sensor arrays records the interference pattern corresponding to the test object volume, and remaining ones of the mosaic of sensor arrays record additional interference patterns corresponding to other, adjacent test object volumes, and
the electronic control module is further configured to:
stitch the interference pattern and the additional interference patterns into an extended interference pattern corresponding to an extended volume of the test object, the extended volume of the test object comprising the test object volume and the other, adjacent test object volumes, and
determine information about defects of the extended volume of the test object.

31. A method for determining information about one or more defects on or in a test object, the method comprising:
illuminating a test object with spatially coherent light;
detecting an interference pattern of light associated with one or more defects on or in the illuminated test object; and
processing the interference pattern to determine information about the one or more defects on or in the test object.

32. The method of claim 31, further comprising producing the interference pattern from the spatially coherent light that transmits through at least a portion of the test object without being scattered and source light which is scattered by the one or more defects.

33. The method of claim 32, wherein
the spatially coherent light transmits through a volume of the test object extending from an entry surface of the test object to an exit surface of the test object within a field of view of a multi-element detector used to detect the interference pattern, and
the one or more defects are on the entry surface, on the exit surface, or in the volume of the test object within or adjacent the field of view.

34. The method of claim 33, wherein said processing the interference pattern to determine information about the one or more defects on or in the test object comprises
processing the interference pattern to determine characteristics of the source light at two or more surfaces of the test object, the two or more surfaces comprising any combination of the entry surface, the exit surface, or one or more inner surfaces within the volume of the test object,
determining the information about the one or more defects from the determined characteristics, and
classifying the one or more defects based on the determined information as one or more of (a) a scratch or dig of the entry or exit surfaces, (b) a void located inside the test object volume, and (c) debris located on the entry or exit surfaces or at one of the inner surfaces of the test object volume.

35. The method of claim 34, wherein
the determined characteristics of the source light comprise two or more of amplitude, phase or intensity, and
the two or more surfaces are separated by distances larger than or equal to an axial resolution.

36. The method of claim 31, further comprising producing the interference pattern from the spatially coherent light which reflects from at least a portion of the test object without being scattered and source light which is scattered by the one or more defects.

37. The method of claim 36, wherein
the spatially coherent light reflects from a test surface of the test object, the test surface being within a field of view of a multi-element detector, and
the one or more defects are on the test surface within or adjacent the field of view of the multi-element detector.

38. The method of claim 37, wherein said processing the interference pattern to determine information about the one or more defects on or in the test object comprises
processing the interference pattern to determine characteristics of the source light at the test surface of the test object,
determining the information about the one or more defects from the determined characteristics, and
classifying the one or more defects based on the determined information as a defect having a type comprising one or more of (a) a scratch or dig of the test surface, and (b) debris located on the test surface.

39. The method of claim 38, wherein the determined characteristics of the source light comprise two or more of amplitude, phase or intensity.

40. The method of claim 31, wherein said detecting the interference pattern is performed without using any imaging optics between a mount that supports the test object and a multi-element detector that detects the interfering pattern.
